(19) United States
(12) Patent Application Publication
(10) Pub. No.: US 2007/0288148 A1
(43) Pub. Date: Dec. 13, 2007

(54) Adaptive Open Loop Line Pressure Control Of Hydraulic Fluid In An Automatic Transmission

(76) Inventors: Weijia Cui, Troy, MI (US); Gary K. Lowe, Troy, MI (US); Daniel H. Black, Shelby Twp., MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/422,903

(22) Filed: Jun. 8, 2006

(51) Int. Cl. G06F 17/00

(52) U.S. Cl. 701/51

(57) ABSTRACT

A method of carrying out open loop variable line pressure control of hydraulic fluid in a vehicle transmission, wherein an electro-hydraulic valve is used to adjust line pressure. Duty cycle values are updated as a function of transmission hydraulic fluid temperature when the transmission is under closed-loop line pressure control. The updated duty cycles are applied to drive the electro-hydraulic valve when the transmission is under open-loop line pressure control. Preferably, the duty cycle values are also updated as a function of battery voltage.

### FIELD OF THE INVENTION

The present invention relates generally to automatic transmissions, and more particularly to controlling line pressure of hydraulic fluid in an automatic transmission.

### BACKGROUND OF THE INVENTION

Automatic transmissions typically include electronically controlled hydraulic systems. Such electro-hydraulic systems often include hydraulically actuated elements, a hydraulic fluid sump, fluid passages between the sump and elements, and a pump to deliver hydraulic fluid from the sump to the elements through the passages. Some electro-hydraulic systems also include a variable force solenoid (VFS) valve in downstream hydraulic communication with the pump, and a regulator valve downstream of the VFS valve. The VFS valve controls pressure of hydraulic fluid from the pump to a control port of the regulator valve, which in turn regulates line pressure of fluid from the pump. Under closed-loop control of line pressure, a pressure sensor measures line pressure and provides a feedback signal to an electronic controller, to determine and apply a duty cycle to the VFS valve suitable to achieve a desired level of line pressure at any given time.

### SUMMARY OF THE INVENTION

A method of carrying out open-loop variable line pressure control of hydraulic fluid in an automatic transmission. The method includes using an electro-hydraulic valve to adjust variable line pressure, updating open-loop duty cycle values as a function of transmission hydraulic fluid temperature when the transmission is under closed-loop line pressure control, and applying the updated open-loop duty cycle values to drive the electro-hydraulic valve when the transmission is under open-loop line pressure control. In another implementation, the open-loop duty cycle values are instead or additionally updated as a function of battery voltage. According to a presently preferred implementation, a solenoid valve is used to adjust line pressure, and a duty cycle table is updated with the temperature dependent duty cycle values and is applied to drive the solenoid valve under open-loop line pressure control.

### BRIEF DESCRIPTION OF THE DRAWINGS

These and other objects, features and advantages of the present invention will be apparent from the following detailed description of the preferred embodiments and best mode, appended claims and accompanying drawings in which:

FIG. 1 is a block diagram of one exemplary embodiment of a transmission line pressure control system;

FIG. 2 is a flow chart of one exemplary embodiment of a method of controlling transmission line pressure;

FIG. 3A is a plot of time versus component speed and line pressure; and

FIG. 3B is a plot of time versus line pressure and VFS valve duty cycle.

### DETAILED DESCRIPTION OF PREFERRED EMBODIMENTS

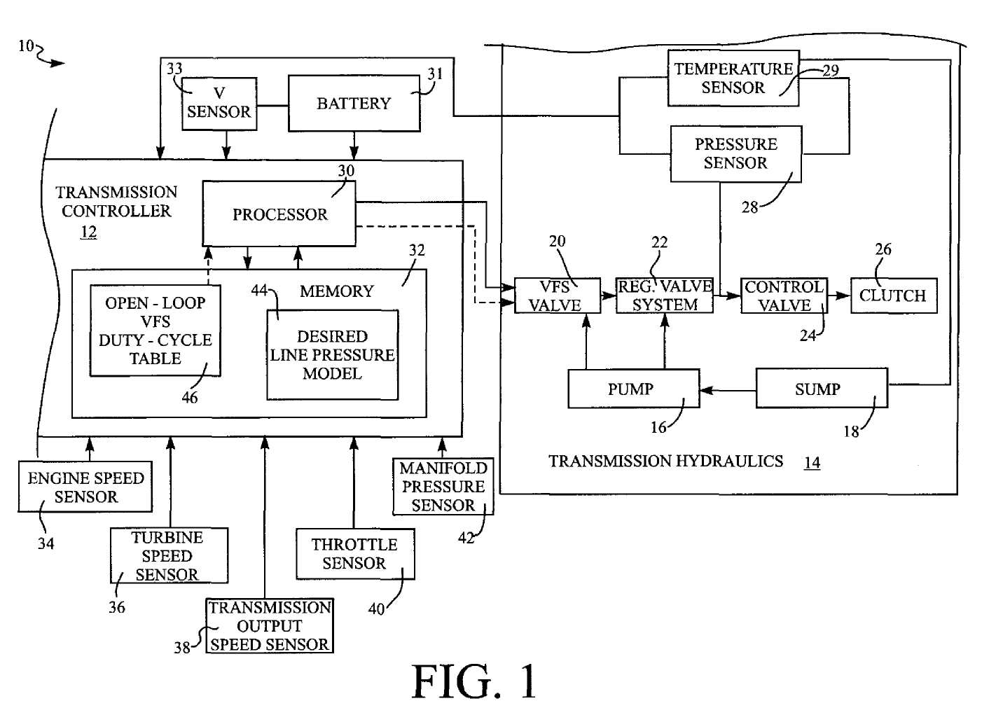

Referring in more detail to the drawings, FIG. 1 illustrates a transmission line pressure control system 10 including at least portions of a transmission controller 12, and a transmission hydraulic system 14 electronically controlled by the transmission controller 12. The system 10 may be adapted for use with any suitable type of automatic transmissions including discrete-speed transmissions, such as three, four, five, six, or seven speed transmissions, or continuously variable transmissions.

The transmission hydraulic system 14 includes a hydraulic pump 16 that delivers hydraulic fluid from a fluid sump 18 to an input port of an electro-hydraulic valve 20 and to a supply port of a regulating valve system 22. As will be discussed in greater detail below, the electro-hydraulic valve 20 may be a solenoid valve such as a variable force solenoid (VFS) valve, and controls pressure of hydraulic fluid from the pump 16 to a control port of the regulating valve system 22. In turn, the regulating valve system 22 regulates pressure of fluid output from the pump 16 to the rest of the hydraulic system 14. The regulated pump pressure is known as line pressure. The regulator valve system 22 can be a single valve such as a spool valve within a valve body, or can be any plurality of separate valve elements of any suitable type.

From the regulating valve system 22, hydraulic fluid at line pressure flows to other portions of the hydraulic system 14 such as a control valve 24. The control valve 24 is used to actuate a hydraulically actuated element 26 such as a friction element, belt sheave, or the like, to effect a change in transmission function such as a change in ratio or the like. Friction elements may include clutches, brake bands, or the like. A pressure sensor 28 measures line pressure downstream of the regulator valve system 22 and provides a feedback signal to the transmission controller 12 for closed-loop line pressure control. A temperature sensor 29 measures temperature of hydraulic fluid at the sump 18 and provides a feedback signal to the transmission controller 12. Transmission hydraulic systems are well known in the art and, therefore, further detailed explanation of various other portions of the hydraulic system 14 is omitted.

The transmission controller 12 generally includes a processor 30, memory 32 suitably coupled to the processor 30, and any other suitable controller elements such as input/output device interfaces, or the like (not shown). The transmission controller 12 may be powered by a battery 31, and a voltage sensor 33 may measure battery voltage at any given time for feedback to the controller 12. The processor 30 may be configured to execute control logic that provides functionality of the system 10, and may encompass one or more microprocessors, field-programmable gate arrays, and/or the like. The memory 32 may include computer readable storage or media in the form of volatile and/or non-volatile memory, such as any kind of random access memory (RAM) or the like for running software and data on the processor 30, and any kind of read only memory (ROM) or the like for storing software and data.

In general, the transmission controller 12 receives input signals from the transmission hydraulic system 14 and other transmission, engine, or vehicle elements. The controller 12 also stores data, executes algorithms or programs, and produces output such as to the transmission hydraulic system 14, including the VFS valve 20. For example, the controller 12 preferably receives signals from the pressure sensor 28, an engine speed sensor 34, a transmission turbine speed sensor 36, a transmission output shaft speed sensor 38, an engine throttle sensor 40, and an engine manifold pressure sensor 42. The controller 12 is preferably programmed to use one or more of the input signals for performing an embodiment of a control method as will be explained in greater detail herein below. The transmission controller 12 is connected to the low side of the VFS valve coil via a semiconductor switch placed between the coil and ground. The controller 12 sends an output command to the VFS valve 20 in the form of a pulse-width-modulated voltage pulse-train at battery voltage to control the VFS valve 20. In turn, the valve 20 controls the regulator valve system 22 to thereby produce a desired level of line pressure. Transmission controllers are well known in the art and, therefore, further detailed explanation of various other portions of the controller 12 is omitted.

Transmission line pressure may be adjusted under either a closed-loop control mode or an open-loop control mode. Open-loop control is invoked in relatively rare circumstances, such as when some system fault renders closed-loop control impractical. So closed-loop control may be the normal mode of line pressure control.

Under one exemplary form of closed-loop line pressure control, the magnitude of the line pressure is continuously or periodically measured by the pressure sensor 28, fed back to the controller 12, and used to manipulate the VFS duty cycle in such a way as to adjust the line pressure toward one or more discrete desired line pressure values. For example, a fixed, relatively high line pressure on the order of 135 psi can be used for shifting a transmission through relatively higher gear ratios, and a fixed, relatively low line pressure on the order of 85 psi can be used for shifting through relatively low gear ratios. In either case, the measured line pressure value is continuously or periodically compared to the desired line pressure values and the difference therebetween is used to change the value of the VFS duty cycle.

Another form of closed-loop control is variable line pressure control, wherein line pressure is intentionally varied between lower and upper pressure limits to achieve an optimal running condition. More specifically, line pressure can be varied according to the type of shift, the type of hydraulically actuated element involved, and present shift conditions to identify and target a minimal line pressure sufficient to carry out an engagement of a hydraulically actuated element without excessive slippage. Transmission slip is typically sensed by observing unusual differences of transmission turbine shaft speed and transmission output shaft speed. Those skilled in the art will recognize that such differences can be sensed as unacceptable differentials in signals received from the speed sensors 34, 36, 38.

Sufficient hydraulic line pressure is used to firmly engage the hydraulically actuated elements 26 to transmit torque from the transmission input shaft to the transmission output shaft, with little to no rotational slippage therebetween. If insufficient line pressure is provided, the frictional elements do not fully engage and slip occurs resulting in power loss through the transmission. Conversely, if excessive line pressure is provided, the hydraulic pump torque is higher than necessary resulting in decreased fuel efficiency of the vehicle.

According to closed-loop variable line pressure control, the controller 12 determines whether there is transmission slippage and, if so, the VFS valve duty cycle may be adjusted until an engagement with minimal slip occurs. Also, the controller memory 32 may be provided with a mathematical model 44 of desired line pressure. The line pressure model 44 uses input signals from the various sensors as well as from predetermined and stored hydraulic element torque capacity data. The model 44 uses such data with suitable algorithms and/or equations to calculate, at any given time under any given conditions, a line pressure suitable to actuate one or more hydraulic elements 26 such as a clutch. In other words, the desired line pressure may be calculated to produce a low or no slip engagement based on a torque capacity of the involved clutch under any given conditions.

More particularly, the controller 12 may command the VFS valve 20 to achieve the desired line pressure to ensure satisfactory engagement of the hydraulically actuated element 26 based on a determination of torque such as from signals the controller 12 receives from the speed sensors 34, 36, 38 (or a torque sensor, if used). The controller 12 uses these input signals along with signals from the engine throttle sensor 40 and manifold pressure sensor 42 to generate and send a duty cycle output signal to the VFS valve 20. The duty cycle values represent the desired percentage of VFS valve on time relative to total VFS valve on and off time. Thus, the VFS valve 20 adjusts the appropriate fluid pressure output from the regulating valve system 22 to maintain line pressure at a satisfactory level according to present transmission and vehicle conditions and vehicle driver demand. For example, when the vehicle is under minimal loading conditions, it may be desirable to operate the transmission with a reduced line pressure. As such, based on the optimum desired line pressure, the VFS valve 20 is energized and, thus, control pressure is applied to the regulating valve system 22, thereby resulting in reduced line pressure. Similarly, when the vehicle is under high load conditions, the transmission could experience clutch slippage. In this situation, the controller 12 commands the VFS valve 20 to apply little to no control pressure to the regulating valve system 22, thereby providing an increased line pressure to more firmly engage the hydraulically actuated element 26 being applied.

In contrast, under open-loop line pressure control, VFS duty cycle is derived from fixed values to provide fixed line pressure that does not vary substantially when drive torque changes, and line pressure feedback is not used. For example, the controller memory 32 may be provided with an open-loop VFS duty cycle look up table 46 as a model. The duty cycle look up table 46 includes a plurality of hydraulic fluid temperatures and corresponding duty cycles. The temperatures and duty cycles can be discrete values, ranges of values, or the like. Typically, open-loop duty cycle values are empirically derived from a plurality of pre-production test vehicles during calibration of a particular transmission design. Thus, open-loop duty cycle values usually provide a mere approximation to what any given particular vehicle transmission may demand at any given temperature, and at any given battery voltage.

But this may not be preferable because the look up table 46 does not take into account the fact that manufactured transmissions of a common design vary in characteristics from one particular transmission to another. For example, each transmission or vehicle is subject to variation in fluid temperature and battery voltage, and to some acceptable production variability in performance of clutch return springs, friction elements, battery voltage, component surface finish and flatness, and hydraulics. Such variability may be due to component wear and dimensional variations, and various component and system changes over the life of a transmission. Because the calibration derived duty cycle values in the look up table cannot take into account each and every such variation, use of the calibration derived duty cycles may result in insufficient line pressures and concomitant clutch slippage, or may yield excessive line pressure and concomitant harsh shifts, transmission damage, or reduced fuel economy. Therefore, the open-loop duty cycle values are preferably variable, and “learned” from the experience of closed-loop line pressure control of an individual transmission, as will be described in greater detail below.

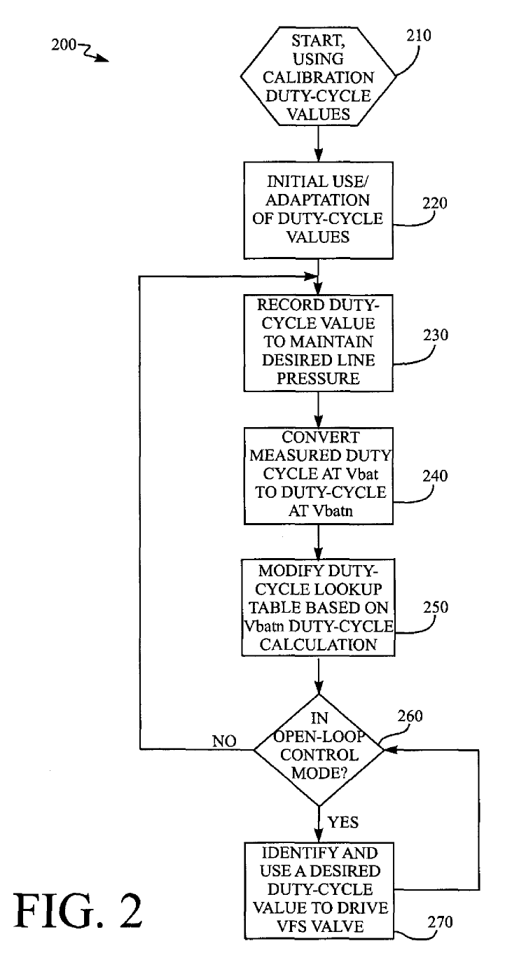

FIG. 2 illustrates an embodiment of a method 200 of carrying out variable line pressure control of automatic transmission hydraulic fluid. The method 200 may, for example, be manifest in a software program stored and implemented by a transmission controller. Generally, according to the method 200, a duty cycle look up table is passively updated during closed-loop variable line pressure control and, when a transmission is under open-loop variable line pressure control, the look up table is actively applied in driving the VFS valve to control line pressure. More particularly, steps 210 through 260 describe a process of temperature-dependent and battery voltage dependent duty cycle learning, which occurs during normal vehicle driving conditions and when the transmission is under closed-loop variable line pressure control. And, steps 260 through 270 describe a process of applying learned duty cycles from the look up table when the transmission is under open-loop variable line pressure control. The method 200 may, for example, be an individual sub-routine of a comprehensive line pressure control program, or may be distributed as various steps throughout such a control program, or the like.

Referring now to steps 210-220, the duty cycle look up table is initialized with duty cycle values that are as close as possible to optimal values, before the duty cycle learning process has a chance to be carried out. In step 210, and when the vehicle is new, the duty cycle look up table is first initialized with calibration derived duty cycle values, which are dependent on hydraulic fluid temperature and independent of battery voltage. Accordingly, if a closed-loop fault occurs before the open-loop duty cycle learning takes place, then calibration derived duty cycle values will be used.

In step 220, all calibration derived duty cycle values in the look up table are eventually replaced with one or more duty cycle values derived during an initial duty cycle value learning event, such as immediately following a gear ratio change, independent of particular temperatures or temperature ranges (as long as the fluid is within a predefined acceptable temperature range). For example, in a discrete gear ratio transmission, the duty cycle values are preferably initially derived immediately following an initial second to third gear upshift that occurs when the fluid temperature is at normal temperatures. Under closed-loop line pressure control, the system will “learn” the duty cycle to achieve the desired line pressure to effectuate a satisfactory second to third gear upshift occurring within a normal operating temperature range of the transmission hydraulic fluid. This initial duty cycle adaptation is an intermediate step, between merely using the calibration derived values, and using more finely tuned temperature-dependent duty cycle values. Accordingly, in the event of a closed-loop control system fault before the duty cycle look up table can be finely tuned or learned, open-loop line pressure control can be carried out using a transmission-specific duty cycle value instead of using general calibrated derived values from step 210. But the initial duty cycle values from step 220 still do not take into account the fluid temperature variations and concomitant effects on the system.

Therefore, to more finely tune the table to take into account the variations in fluid temperature and battery voltage, the duty cycle values in the duty cycle look up table are further adapted or modified from the values generated in step 220. In other words, step 230 is carried out to yield temperature-dependent duty cycle values and steps 240 and 250 are carried out to yield battery voltage dependent duty cycle values.

In step 230, average duty cycle values to maintain desired line pressures are determined and recorded. At step 230, the fluid temperature is observed and used to identify corresponding duty cycle values in the look up table. Also, at step 230, the magnitude or value of battery voltage during a given applied duty cycle may also be determined and recorded for later use with steps 240 and 250.

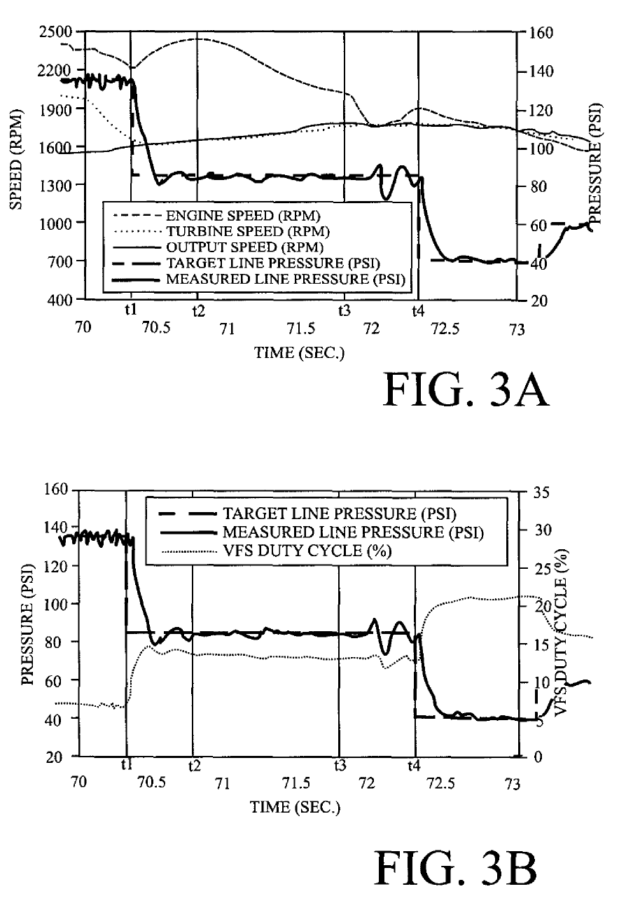

In one implementation, the following substeps of step 230 are carried out during closed-loop variable line pressure control. Under closed-loop line pressure control, fixed line pressure is applied during a gear ratio change, and variable line pressure is applied after a gear ratio change. First, under closed-loop line pressure control, an initial target line pressure is set to some predetermined value such as just after a change in gear ratio is carried out. For example, and referring now to FIGS. 3A and 3B, at time t1 it is determined that a change in gear ratio has just been carried out and, thus, the controller commands the VFS valve according to variable duty cycle values (shown in thin solid line in FIG. 3B) to adjust line pressure downward to a target value (such as 85 psi, as shown in heavy dashed line). The target value for line pressure can be, for example, a value determined during transmission calibration, a value determined in accordance with step 220 above, or a value determined based on a hardware requirement such as clutch capacity. At time t2, engine speed (shown in light dashed line) falls within an expected suitable range, and actual line pressure (shown in heavy solid line) suitably stabilizes.

Then, the variable duty cycle values for adjusting the line pressure toward the target value are averaged over a suitable range of time, such as from t2 to t3, or from t2 to t4. Because engine speed influences output of the transmission hydraulic pump and, thus, influences line pressure for a given VFS duty cycle, the range of engine speed for observing and recording the average VFS duty cycle is preferably near a common or typical engine speed for normal driving conditions. Thus, the range of time is selected in relation to this engine speed range.

Over a predetermined period, such as from t2 to t4, engine speed is observed for the instant at which engine speed falls out of a predetermined range, or below a predetermined value such as about 2000 rpm at t3. If engine speed suitably falls at t3, then duty cycle values are averaged over t2 to t3. If, however, engine speed stays within the predetermined range, or does not fall below the predetermined minimal value, over the predetermined period, then duty cycle values are averaged over t2 to t4.

The average duty cycle is saved to controller memory in the open-loop duty cycle look up table. For example, from time t2 to t3, present temperature of the hydraulic fluid is observed and used to determine where to save the average duty cycle value in the look up table. The present temperature is used to identify a corresponding saved temperature, and the average duty cycle is saved in correspondence to this saved temperature. This average duty cycle is the open-loop duty cycle value to be used to adjust line pressure toward a target or desired value in the event that open-loop control is invoked. Alternatively, the average duty cycle over t2 to t3 may be further manipulated in step 240, before being saved to the duty cycle look up table for use during open-loop control.

In step 240, the average duty cycle from step 230 is recalled along with its corresponding battery voltage value observed between t2 and t3, and is then converted to a duty cycle value at a nominal battery voltage. Because the battery voltage of the vehicle varies over time and, because the VFS valve operates on this fluctuating voltage, the open-loop line pressure concomitantly varies for any given fixed VFS duty cycle value being applied. Therefore, to achieve a relatively constant open-loop line pressure under varying battery voltage, the duty cycle determined in step 230 is converted to a duty cycle that would maintain the desired line pressure at a nominal battery voltage, for example, 13.5 Volts.

The calculations for compensating for battery voltage variations may include several assumptions. First, the VFS valve is driven with periodic pulse width modulated voltage pulses and the magnitude of the voltage pulses is the battery voltage. Second, the line pressure is a monotonic function of the averaged magnetic force of the VFS valve. Third, the magnetic force is linearly related to the electric current passing through the coil of the VFS valve. Fourth, the inductance of the VFS valve coil is relatively constant during operation.

From the foregoing assumptions, the line pressure is monotonically related to the average current flowing through the VFS valve coil. Because the VFS valve coil is driven with periodic voltage pulses, the current through the coil can be described according to Equation 1 below:

$$I = {I}_{0} + \sum {I}_{m} sin ( \frac{m t}{T} + {Θ}_{m} ) , \\ wherein \qquad ( Eq . 1 )$$

Ī=I₀,

Iₘ=magnitude of AC current at the m^{th} harmonics of the VFS duty cycle,

m=harmonic of the VFS duty cycle,

t=time,

T=the period of the VFS duty cycle,

Θm=VFS phase shift, and

I₀=magnitude of DC current component, and can be expressed as follows

$${I}_{0} = \frac{1}{T} {\int }_{0}^{T} \frac{V ( t )}{R} d t = DC \% * \frac{{V}_{batn}}{R} \qquad ( Eq . 2 )$$

By maintaining 1o constant, line pressure can be maintained constant even if battery voltage changes from one level to another, as illustrated below:

$${DC}_{n} \% * \frac{{V}_{batn}}{R} = DC \% * \frac{{V}_{bat}}{R} , \\ which is further simplified below \frac{DC \%}{{DC}_{n} \%} = \frac{{V}_{batn}}{{V}_{bat}} , \\ which yields \\ {DC}_{n} \% = DC \% \frac{{V}_{bat}}{{V}_{batn}} , \\ wherein \qquad ( Eq . 3 )$$

DCₙ % is the duty cycle to maintain a given line pressure at nominal battery voltage V_{batm}, and DC % is the duty cycle for the given line pressure at present battery voltage V_{bat}.

At step 250, the nominal battery voltage duty cycle value is saved to a suitable location in the look up table. More specifically, each learned and calculated DCₙ % for each given transmission fluid temperature or temperature range is used to modify or adapt one or more corresponding or nearest duty cycle values of the open-loop duty cycle look up table. In other words, the present temperature is observed and used to reference a corresponding breakpoint temperature value in the look up table, and the duty cycle value adjacent or corresponding to the reference temperature value is replaced with the DCₙ % value. When the observed present temperature falls between breakpoint temperature values in the look up table, then the table duty cycle value(s) corresponding to one or both of the nearest breakpoint temperature values can be calculated by weighting the duty cycle values in proportion to their distance from the learned and calculated DCₙ %.

At step 260, it is determined whether the system is in open-loop control mode or not. If not, then the process loops back to step 230 and proceeds through step 260 again, thereby continuously updating the duty cycle look up table wherein the system learns suitable duty cycle values across a plurality of temperatures for potential use in open-loop control. But if so, then the method proceeds to step 270, wherein the VFS valve is commanded using duty cycle values from the open-loop look up table. In contrast to closed-loop line pressure control, under open-loop line pressure control variable line pressure is applied during and after a change in gear ratio.

At step 270, in general, a desired duty cycle value from the open-loop look up table is identified and used to drive the VFS valve. The processor executes a suitable routine to linearly interpolate between the discrete duty cycle values based on the present temperature. More specifically, a present hydraulic transmission fluid temperature is observed and used in conjunction with the look up table to reference corresponding temperatures and duty cycles, linearly interpolate therebetween, and thereby identify a corresponding duty cycle value. This interpolated duty cycle value could be used to drive the VFS valve at nominal battery voltage if desired. But preferably, present battery voltage is then observed, and Equation 4 is executed by the processor to convert the interpolated duty cycle value to the duty cycle value at the present, observed, battery voltage. Thereafter, the calculated duty cycle DC % is used to drive the VFS valve.

Accordingly, the method 200 provides an accurate and reliable process of controlling line pressure when variable line pressure is under open-loop control, despite variations in fluid temperature and/or battery voltage in a given transmission, or in component or system characteristics across individual transmissions of a common design.

While certain preferred embodiments have been shown and described, persons of ordinary skill in this art will readily recognize that the preceding description has been set forth in terms of description rather than limitation, and that various modifications and substitutions can be made without departing from the spirit and scope of the invention. The invention is defined by the following claims.

What is claimed is:

1. A method of carrying out variable line pressure control of hydraulic fluid in an automatic transmission, the method comprising the steps of:
using a solenoid valve to adjust variable line pressure;
updating an open loop duty cycle table with temperature dependent duty cycle values when the transmission is under closed-loop line pressure control; and
applying the updated open loop duty cycle table to drive the solenoid valve when the transmission is under open-loop line pressure control.

2. The method of claim 1 wherein the updating step is further carried out using battery voltage dependent duty cycle values.

3. The method of claim 1 wherein, during the updating step, the table is initialized with at least one duty cycle value derived from transmission calibration.

4. The method of claim 1 wherein, during the updating step, the table is initialized with at least one duty cycle value derived during a first duty cycle value learning event.

5. The method of claim 1 wherein, during the updating step, the table is first initialized with at least one fixed duty cycle value derived from transmission calibration, and subsequently initialized with at least one temperature independent duty cycle value derived during a first duty cycle value learning event.

6. The method of claim 1 wherein the updating step comprises:
commanding the solenoid valve according to variable duty cycle values to adjust line pressure toward a target value;
observing at least one of engine speed falling below a predetermined threshold or engine speed staying within a predetermined range over predetermined period;
averaging the variable duty cycle values between the commanding and observing steps to yield an average duty cycle value;
observing hydraulic fluid temperature; and
saving the average duty cycle value to the table in correspondence to the fluid temperature.

7. The method of claim 1 wherein the updating step comprises:
commanding the solenoid valve according to variable duty cycle values to adjust line pressure toward a target value;
observing at least one of engine speed falling below a predetermined threshold or engine speed staying within a predetermined range over predetermined period;
averaging the duty cycle values between the commanding and observing steps to yield an average duty cycle value;
observing hydraulic fluid temperature;
converting the average duty cycle value to a duty cycle value at a nominal battery voltage; and
saving the nominal battery voltage duty cycle value to the table in correspondence to a table temperature, which in turn corresponds to the observed hydraulic fluid temperature.

8. The method of claim 7 further comprising the steps of:
determining whether the system is in open-loop variable line pressure control mode;
observing present fluid temperature;
using the observed present hydraulic fluid temperature in conjunction with the table to reference corresponding hydraulic fluid temperatures, linearly interpolate between the hydraulic fluid temperatures, and calculate at least one corresponding nominal battery voltage duty cycle value;
observing present battery voltage;
converting the nominal battery voltage duty cycle value to a present battery voltage duty cycle value; and
applying the present battery voltage duty cycle value to drive the solenoid valve.

9. A method of carrying out variable line pressure control of hydraulic fluid in an automatic transmission, the method comprising the steps of:
using an electro-hydraulic valve to adjust variable line pressure;
updating open-loop duty cycle values as a function of hydraulic fluid temperature when the transmission is under closed-loop line pressure control; and
applying the updated open-loop duty cycle values to drive the electro-hydraulic valve when the transmission is under open-loop line pressure control.

10. The method of claim 9, wherein the updating step comprises:
commanding the electro-hydraulic valve according to variable duty cycle values to adjust line pressure toward a target value;
observing at least one of engine speed falling below a predetermined threshold or engine speed staying within a predetermined range over predetermined period;
averaging the variable duty cycle values between the commanding and observing steps to yield an average duty cycle value;
observing hydraulic fluid temperature; and
saving the average duty cycle value in correspondence to the observed hydraulic fluid temperature.

11. The method of claim 9, wherein the updating step comprises:
commanding the electro-hydraulic valve according to variable duty cycle values to adjust line pressure toward a target value;
observing at least one of engine speed falling below a predetermined threshold or engine speed staying within a predetermined range over predetermined period;
averaging the duty cycle values between the commanding and observing steps to yield an average duty cycle value;
observing hydraulic fluid temperature;
converting the average duty cycle value to a duty cycle value at a nominal battery voltage; and
saving the nominal battery voltage duty cycle value in correspondence to the observed hydraulic fluid temperature.

12. The method of claim 11, wherein the further comprising the steps of:
determining whether the system is in open-loop variable line pressure control mode;
observing present hydraulic fluid temperature;
using the observed present hydraulic fluid temperature in conjunction to reference corresponding hydraulic fluid temperatures of the table, linearly interpolate between the hydraulic fluid temperatures, and thereby calculate at least one corresponding nominal battery voltage duty cycle value;
observing present battery voltage;
converting the nominal battery voltage duty cycle value to a present battery voltage duty cycle value; and
applying the present battery voltage duty cycle value to drive the electro-hydraulic valve.

13. A method of carrying out variable line pressure control of hydraulic fluid in an automatic transmission, the method comprising the steps of:
using an electro-hydraulic valve to adjust variable line pressure;
updating open-loop duty cycle values as a function of battery voltage when the transmission is under closed-loop line pressure control; and
applying the updated open-loop duty cycle values to drive the electro-hydraulic valve when the transmission is under open-loop line pressure control.

14. The method of claim 13 wherein the updating step also comprises:
updating the open-loop duty cycle values as a function of hydraulic fluid temperature;
commanding the electro-hydraulic valve according to variable duty cycle values to adjust line pressure toward a target value;
observing at least one of engine speed falling below a predetermined threshold or engine speed staying within a predetermined range over predetermined period;
averaging the duty cycle values between the commanding and observing steps to yield an average duty cycle value;
observing hydraulic fluid temperature;
converting the average duty cycle value to a duty cycle value at a nominal battery voltage; and
saving the nominal battery voltage duty cycle value in correspondence to the observed hydraulic fluid temperature.

15. The method of claim 14 further comprising the steps of:
determining whether the system is in open-loop variable line pressure control mode;
observing present hydraulic fluid temperature;
using the observed present hydraulic fluid temperature to reference corresponding hydraulic fluid temperatures of the table, linearly interpolate between the hydraulic fluid temperatures, and thereby calculate at least one corresponding nominal battery voltage duty cycle value;
observing present battery voltage;
converting the nominal battery voltage duty cycle value to a present battery voltage duty cycle value; and
applying the present battery voltage duty cycle value to drive the electro-hydraulic valve.
